(19) United States
(12) Patent Application Publication
(10) Pub. No.: US 2026/0356164 A1
(43) Pub. Date: Nov. 12, 2026

(54) VEHICLE HEATER DEVICE

(71) Applicant: TOYODA GOSEI CO., LTD., Kiyosu-shi (JP)

(72) Inventors: Shota HASHIZUME, Kiyosu-shi (JP); Nobuhiro TERAI, Kiyosu-shi (JP)

(21) Appl. No.: 19/643,925

(22) Filed: Apr. 10, 2026

(30) Foreign Application Priority Data
May 9, 2025 (JP) 2025-078696

(51) Int. Cl. B60H 1/22

(52) U.S. Cl. CPC B60H 1/2225

(57) ABSTRACT

A vehicle heater device includes: a heater as a heat source; a case accommodating the heater; a cover part having a hole region portion in which a plurality of through-holes connecting inside and outside of the case are provided, the cover part being provided at least in a part of a front face of the case; and a functional part having an exposure region portion exposed at a front face of the cover part or the front face of the case. The exposure region portion is disposed outside the hole region portion. The heater is disposed at a position at which the heater opposes and overlaps the hole region portion and at which the heater does not oppose or overlap the exposure region portion, in a front-rear direction of the case.

### TECHNICAL FIELD

The present disclosure relates to a vehicle heater device.

### BACKGROUND ART

To date, vehicle heater devices installed in vehicles have been known (e.g., JP2015-145182(A)). A vehicle heater device described in JP2015-145182(A) includes a heater as a heat source, a case accommodating the heater, and a cover part provided at the front face of the case and facing the vehicle inner side. The cover part is provided with a plurality of through-holes. The region, in the cover part, where the through-holes are provided is set so as to oppose and overlap the heater present on the far side of the cover part in the front-rear direction of the case. Heat generated by the heater is transmitted through the inside of the case and released, as radiant heat, to the vehicle inner side through the through-holes in the cover part.

### SUMMARY

### Technical Problem

Meanwhile, since the vehicle heater device is for releasing heat to the vehicle inner side, a logo or warning of the vehicle heater device needs to be displayed to the vehicle occupant, and an operation switch for switching between activation and deactivation of the heater needs to be provided. However, in the vehicle heater device described in the above JP2015-145182(A), the positions where functional parts such as the logo and warning and the operation switch are disposed with respect to the case accommodating the heater are not clear, and thus, the sense of unity of the functional parts with the case may be impaired.

Meanwhile, if the above functional parts are disposed at the front face of the case regardless of the position at which the heater is disposed, heat from the heater may be hindered from being released to the outside of the case, due to the presence of the functional parts, resulting in decrease in thermal performance inside the vehicle or a high temperature in the case, and consequently, the functional parts may be easily deteriorated.

The present disclosure has been made in view of such problems. An object of the present disclosure is to provide a vehicle heater device capable of preventing impairment of releasability of heat from the heater, to the vehicle inner side, while ensuring the sense of unity of the functional part with the case.

### Solution to Problem

An aspect of the present disclosure is a vehicle heater device including: a heater as a heat source; a case accommodating the heater; a cover part having a hole region portion in which a plurality of through-holes connecting inside and outside of the case are provided, the cover part being provided at least in a part of a front face of the case; and a functional part having an exposure region portion exposed at a front face of the cover part or the front face of the case. The exposure region portion is disposed outside the hole region portion. The heater is disposed at a position at which the heater opposes and overlaps the hole region portion and at which the heater does not oppose or overlap the exposure region portion, in a front-rear direction of the case.

According to this configuration, while the sense of unity of the functional part with the case is ensured, impairment of releasability of heat from the heater, to the vehicle inner side, is prevented.

### BRIEF DESCRIPTION OF DRAWINGS

FIG. 1 is a perspective view of a vehicle heater device viewed from the vehicle inner side, according to an embodiment of the present disclosure;

FIG. 2 is an exploded perspective view of the vehicle heater device of the present embodiment;

FIG. 3 is a front view of the vehicle heater device of the present embodiment, viewed from the vehicle inner side;

FIG. 4 is a cross-sectional view at IV-IV shown in FIG. 3;

FIG. 5 illustrates that the sizes of through-holes in a cover part in the vehicle heater device of the present embodiment differ between an upper region and a lower region;

FIG. 6 is a diagram in which the sizes of through-holes in the cover part in the vehicle heater device of the present embodiment are compared between the upper region and the lower region;

FIG. 7 is a cross-sectional view at VII-VII shown in FIG. 3; and

FIG. 8 illustrates a relationship between a hole region portion and an exposure region portion in the vehicle heater device of the present embodiment.

### DESCRIPTION OF EMBODIMENTS

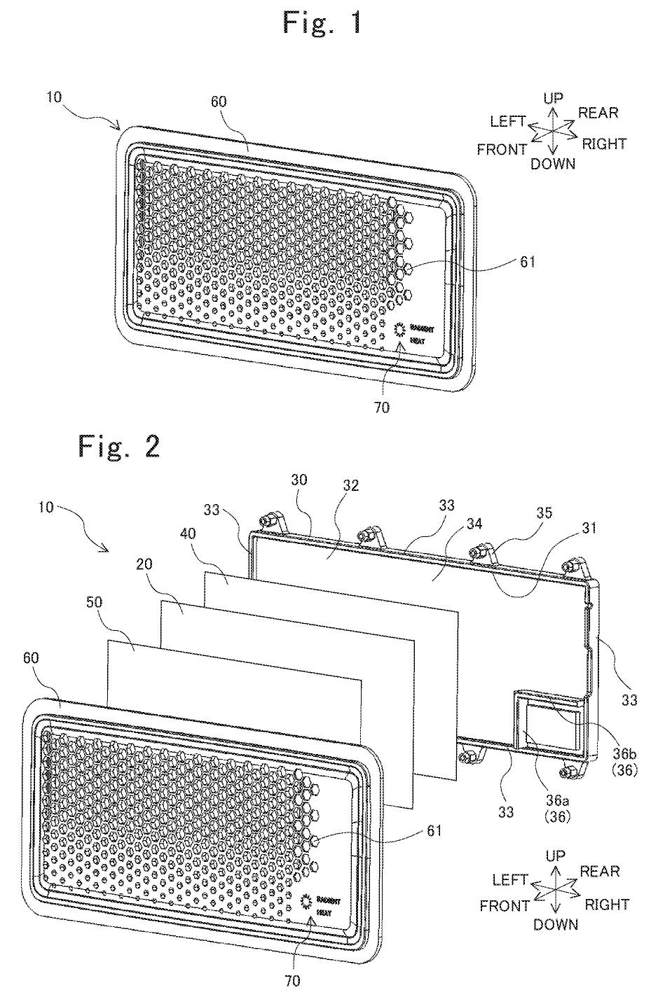

Hereinafter, with reference to FIGS. 1 - 8, a specific embodiment of a vehicle heater device according to the present disclosure is described. In the present embodiment, “front”, “rear”, “right”, and “left” directions are based on the state where the vehicle heater device mounted to an interior member of the vehicle is viewed from the vehicle inner side. The direction orthogonal or substantially orthogonal to the front face of the vehicle heater device and connecting the near side as the vehicle inner side and the rear side as the far side is referred to as “front-rear direction”. The “up” and “down” directions denote the vertical direction.

A vehicle heater device 10 of the present embodiment is a heating device for warming the inside (particularly, vehicle occupant) of the vehicle. The vehicle heater device 10 is mounted to an interior member of the vehicle. This interior member is, for example, a dashboard, an instrument panel, a steering column, a center console, a door trim, or the like. The vehicle heater device 10 is installed at a wall surface, of the interior member, facing the inside of the vehicle.

The vehicle heater device 10 may be any vehicle heater device that releases heat generated by a heater to the inside of the vehicle. The heat release orientation may be any orientation, and, for example, may be toward the rear of the vehicle or toward the front of the vehicle. Further, in order to warm leg portions of the vehicle occupant, the heat release orientation may be obliquely downward from below the dashboard toward the rear of the vehicle, or further, may be from the center console toward the left and right sides, i.e., toward the spaces below the seats.

The vehicle heater device 10 is an electrical heating device that generates heat by being supplied with electric power from a power supply such as an in-vehicle battery or a generator, and is a radiation-type heater that warms the vehicle occupant by radiant heat. As shown in FIGS. 1, 2, 3, and 4, the vehicle heater device 10 includes a heater 20, a case 30, a heat insulating member 40, a heat storage member 50, a cover part 60, and a functional part 70.

The heater 20 is a heat source that generates heat by being supplied with electric power. The heater 20 is formed in a plate shape. The heater 20 is formed in a quadrangular shape or a substantially quadrangular shape. The heater 20 is configured such that, withrespect to a substrate, a linear heating element is distributed over the entire region of the substrate, for example. This heating element is formed from a metal material such as copper or silver, for example. The heater 20 releases, as radiant heat, heat generated by the heating element, mainly from the front face to the vehicle inner side, in a direction perpendicular to the front face.

The case 30 is a base member that accommodates the heater 20. The case 30 is formed in a rectangular parallelepiped shape having an opening 31 in the front face thereof. The opening 31 in the frame body of the front face of the case 30 is formed in a quadrangular shape or a substantially quadrangular shape. The case 30 has a rear wall portion 32 and four side wall portions 33. The rear wall portion 32 and the four side wall portions 33 form an accommodation space 34 in which the heater 20, the heat insulating member 40, the heat storage member 50, and the functional part 70 are accommodated. The heater 20 is supported on the rear wall portion 32 side in the accommodation space 34 of the case 30.

The case 30 is composed of a material having heat resistance and heat insulating properties, such as a foamed material or a urethane resin, for example. The case 30 is provided with a plurality of mounting pieces 35 protruding outward from the side wall portions 33. The case 30 is mounted and fixed to the back side of an interior member with the plurality of mounting pieces 35.

The heat insulating member 40 is a member that inhibits heat from the heater 20 from being released to the back side. The heat insulating member 40 is interposed between the heater 20 and the rear wall portion 32 of the case 30. The heat insulating member 40 is formed in a sheet shape and is formed to have a size adjusted to the size of the heater 20.

The heat storage member 50 is a member that stores heat from the heater 20. The heat storage member 50 is disposed adjacent, on the frontside, to the heater 20. The heat storage member 50 is formed in a sheet shape, stores heat from the heater 20, and releases the heat frontward in a uniform distribution.

The cover part 60 is a member that is provided to the front face of the case 30 and that covers the opening 31. The cover part 60 is formed in a quadrangular shape or a substantially quadrangular shape adjusted to the shape of the front face of the case 30. The cover part 60 is provided separately from the case 30. The cover part 60 is mounted to the case 30 by claw fitting, bolt fastening, or the like. The cover part 60 may be formed integrally with the case 30. The cover part 60 is composed of a material having heat resistance. Preferably, the cover part 60 is composed of a material having heat insulating properties in order to suppress the temperature of the front face exposed to the vehicle inner side from becoming high.

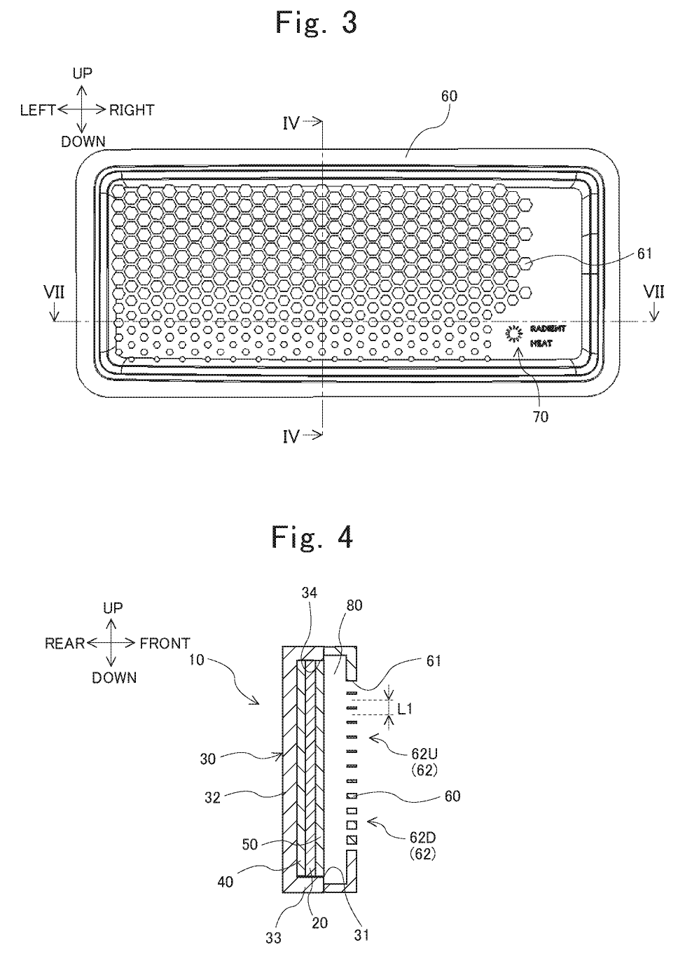

The cover part 60 includes a through-hole 61. The through-hole 61 is a hole connecting the inside (i.e., the accommodation space 34) and the outside of the case 30, and is a hole for releasing heat from the heater 20, to the outside of the case 30. The through-hole 61 is formed in a regular hexagonal shape, a circular shape, or the like, for example. The place, in the cover part 60, where the through-hole 61 is provided is separated frontward from the front face of the heat storage member 50 accommodated in the case 30. That is, an air layer 80 is formed between the place, in the cover part 60, where the through-hole 61 is provided, and the front face of the heat storage member 50 (see FIGS. 4 and 7).

A plurality of the through-holes 61 are provided. The through-holes 61 are uniformly provided over most of the region of the cover part 60. For example, the through-holes 61 are arranged in the up-down direction and are arranged in the left-right direction in the cover part 60. Through-holes 61 adjacent to each other in the left-right direction may be disposed without being shifted in the up-down direction, but, as shown in FIG. 3 and the like, may be obliquely disposed while being shifted by a half pitch in the up-down direction.

In the cover part 60, through-holes 61 arranged in the up-down direction are disposed such that the axes of the through-holes 61 adjacent to each other in the up-down direction maintain a constant distance L1 (see FIG. 4). That is, each through-hole 61 is provided at every constant distance L1 in the up-down direction. Through-holes 61 arranged in the left-right direction are disposed such that the axes of the through-holes 61 adjacent to each other in the left-right direction maintain a constant distance L2 (see FIG. 7). That is, each through-hole 61 is provided at every constant distance L2 in the left-right direction.

The plurality of through-holes 61 in the cover part 60 form a hole region portion 62. That is, the cover part 60 has the hole region portion 62 in which the plurality of through-holes 61 are provided. The hole region portion 62 occupies most of the front face of the cover part 60, and releases heat from the heater 20, over a wide range through the through-holes 61. The hole region portion 62 forms a design region portion having a good design when viewed from the vehicle inner side, due to the array and arrangement of the plurality of through-holes 61, the shape of each through-hole 61, and the like.

The hole region portion 62 is divided into an upper region 62U and a lower region 62D according to the proportion of the size (i.e., area) occupied by the through-holes 61. The upper region 62U is a region positioned on the upper side in the hole region portion 62. The lower region 62D is a region positioned on the lower side in the hole region portion 62 and is adjacent, on the lower side, to the upper region 62U. The upper region 62U is a region where the hole area proportion occupied by the through-holes 61 is relatively large in the entirety of the upper region 62U, and is a region where the area proportion occupied by the plate face portion, of the cover part 60, that is not the through-holes 61 is relatively small. The lower region 62D is a region where the hole area proportion occupied by the through-holes 61 is relatively small in the entirety of the lower region 62D, and is a region where the area proportion occupied by the plate face portion, of the cover part 60, that is not the through-holes 61 is relatively large.

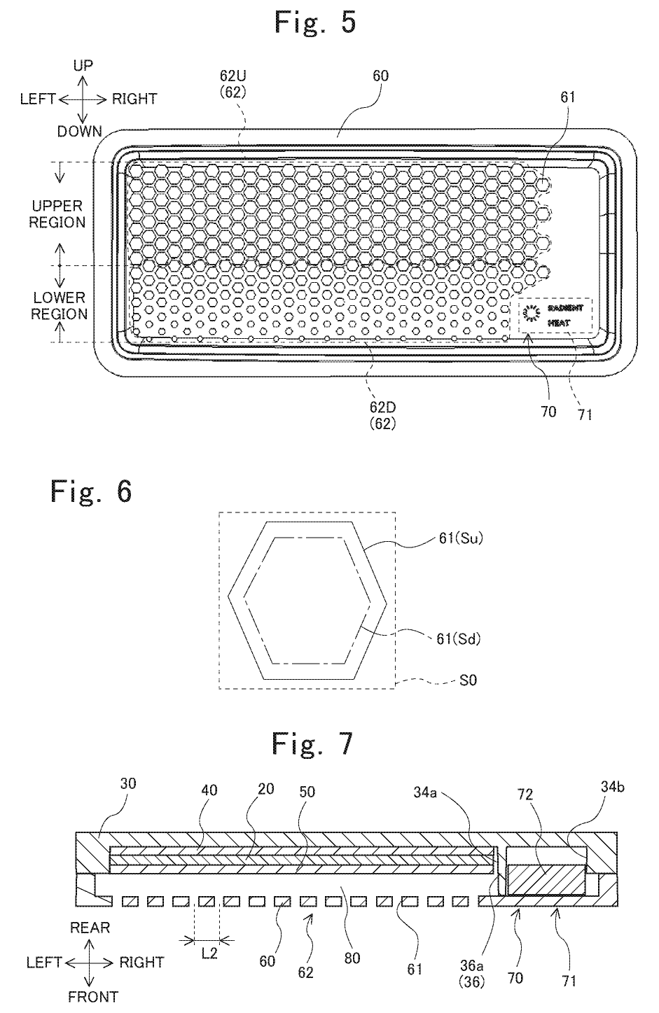

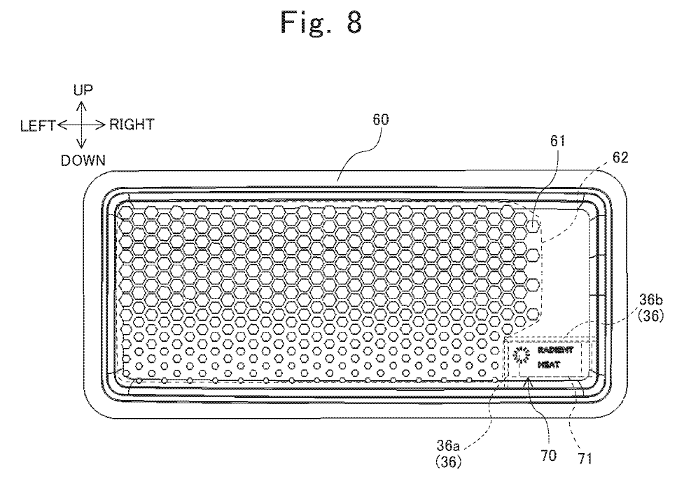

That is, the hole area proportion occupied by the through-holes 61 in the lower region 62D is smaller than the hole area proportion occupied by the through-holes 61 in the upper region 62U. A hole area (Sd) of the through-holes 61 per unit area (S0) in the lower region 62D is smaller than a hole area (Su) of the through-holes 61 per unit area in the upper region 62U. The unit area S0 denotes, for example, the size of a quadrangle capable of containing one through-hole 61, and may be represented by a value obtained by multiplying the distance L1 between the axes of two through-holes 61 arranged adjacent to each other in the up-down direction by the distance L2 between the axes of two through-holes 61 arranged adjacent to each other in the left-right direction. An example of a reference figure having the unit area S0 is indicated by a broken line in FIG. 6.

In the present embodiment, on the premise that the hole area proportion occupied by the through-holes 61 in the lower region 62D is smaller than the hole area proportion occupied by the through-holes 61 in the upper region 62U, the sizes (areas) of the through-holes 61 in the hole region portion 62 differ, as shown in FIG. 6. The size of the through-hole 61 (indicated by an alternate long and short dash line in FIG. 6) in the lower region 62D is generally smaller than the size (indicated by a solid line in FIG. 6) of the through-hole 61 in the upper region 62U. The average value of the sizes of the through-holes 61 in the lower region 62D is smaller than the average value of the sizes of the through-holes 61 in the upper region 62U.

For example, the size of each through-hole 61 in the upper region 62U is 25 mm²to 40 mm², or the like, and the size of each through-hole 61 in the lower region 62D is 5 mm² to 35 mm², or the like. Alternatively, the diameter of each through-hole 61 in the upper region 62U is 5 mm to 8 mm, or the like, and the diameter of each through-hole 61 of the lower region 62D is 2 mm to 7 mm, or the like. Preferably, the maximum value of the size of the through-holes 61 in the lower region 62D is smaller than the minimum value of the size of the through-holes 61 in the upper region 62U. However, the present disclosure is not limited thereto as long as the condition of the hole area proportion described above is satisfied. The maximum value of the size of the through-holes 61 in the lower region 62D may be equal to or larger than the minimum value of the size of the through-holes 61 in the upper region 62U.

The size of the through-holes 61 in the hole region portion 62 may gradually become smaller from the through-holes 61 on the upper side toward the through-holes 61 on the lower side. In this configuration, while the through-holes 61 in the upper region 62U have the same predetermined area with each other, the size of the through-holes 61 in the lower region 62D may gradually become smaller from the through-holes 61 on the upper side toward the through-holes 61 on the lower side. In this case, the size of the through-holes 61 in the lower region 62D is preferably smaller than the predetermined area being the size of the through-holes 61 in the upper region 62U. Conversely, while the size of the through-holes 61 in the upper region 62U gradually becomes smaller from the through-holes 61 on the upper side toward the through-holes 61 on the lower side, the through-holes 61 in the lower region 62D may have the same predetermined area with each other. In this case, the predetermined area of the through-holes 61 in the lower region 62D is preferably smaller than the size of the through-holes 61 at the lowest row in the upper region 62U.

In the example shown in the figures, the through-holes 61 in the upper region 62U have the same predetermined area with each other, and the size of the through-holes 61 in the lower region 62D is smaller than the predetermined area of the through-holes 61 in the upper region 62U, and gradually becomes smaller from the through-holes 61 on the upper side toward the through-holes 61 on the lower side. The size (specifically, the area or the length in the up-down direction) of the upper region 62U is larger than the size (specifically, the area or the length in the up-down direction) of the lower region 62D.

The functional part 70 is a part necessary, for example, for allowing the function of the vehicle heater device 10 to be exhibited, or for indicating the position at which the vehicle heater device 10 is present. The functional part 70 denotes, for example, a logo or illumination indicating the vehicle heater device 10, an operation switch for switching between activation and deactivation of the heater 20, and the like. The functional part 70 has an exposure region portion 71 exposed at the front face of the cover part 60, and an accommodated portion 72 extending on the rear side of the exposure region portion 71 and accommodated in the case 30 (i.e., the accommodation space 34).

The exposure region portion 71 is disposed at a place where the exposure region portion 71 does not overlap the hole region portion 62 in the front face of the cover part 60, i.e., a place different from the hole region portion 62. That is, the exposure region portion 71 is disposed outside the hole region portion 62 in the front face of the cover part 60. For example, as shown in FIG. 1 and the like, the exposure region portion 71 is disposed at a corner (specifically, any one of the four corners in the front face of the cover part 60 having a quadrangular shape) in the front face of the case 30, and is adjacent to, at either of the left and the right (e.g., at the right in FIG. 1) of, the hole region portion 62.

The accommodated portion 72 is disposed on the rear side with respect to the front face of the cover part 60, as shown in FIG. 7. The accommodated portion 72 denotes, for example, a substrate, a connection terminal, a terminal block, a control device, and the like that are connected to the operation switch or illumination disposed in the exposure region portion 71. The control device as the accommodated portion 72 controls activation of the heater 20 through operation of the operation switch, and may, for example, control the electric power to be supplied to the heater 20, to vary the heat generated by the heater 20.

As shown in FIG. 7, the heater 20 is disposed at a position at which the heater 20 opposes and overlaps the hole region portion 62 and at which the heater 20 does not oppose or overlap the exposure region portion 71, in the front-rear direction of the case 30.

The case 30 has a partition plate 36. The partition plate 36 extends so as to spread between the hole region portion 62 and the exposure region portion 71 in the front face of the case 30 (specifically, the cover part 60). The partition plate 36 spreads in the front-rear direction and the up-down direction. The partition plate 36, in combination with the rear wall portion 32 and the side wall portions 33, surrounds the functional part 70 and is separated from the heater 20 side. That is, the partition plate 36 has a function of causing heat from the heater 20 to be less likely to be transmitted to the functional part 70. The partition plate 36 is composed of a material having heat insulating properties. The partition plate 36 is formed integrally with the case 30 or is mounted and fixed to the case 30 afterward.

As shown in FIG. 7, the partition plate 36 sections the accommodation space 34 of the case 30 into a first accommodation space 34a in which the heater 20 is accommodated and a second accommodation space 34b in which the accommodated portion 72 is accommodated. For example, as shown in FIGS. 2 and 7, the partition plate 36 has a first plate part 36a connected to the side wall portion 33 at the lower side and extending upward, and a second plate part 36b connected to the side wall portion 33 at the right side and extending leftward, and connected to the upper end of the first plate part 36a.

Next, operation of the vehicle heater device 10 is described.

When the heater 20 of the vehicle heater device 10 has been activated due to switching of the operation switch or the like, the heater 20 generates heat by being supplied with electric power. The heat generated by the heater 20 is transmitted from the front face to the heat storage member 50, is released, as radiant heat, to the air layer 80 side, and is applied to the vehicle occupant on the vehicle inner side through the through-holes 61 in the cover part 60. Accordingly, the vehicle occupant in the vehicle is warmed by the heat generated by the heater 20.

In the vehicle heater device 10, the hole region portion 62, in the cover part 60, in which a plurality of through-holes 61 are provided is divided into the upper region 62U in which the hole area proportion occupied by the through-holes 61 is relatively large, and the lower region 62D in which the hole area proportion occupied by the through-holes 61 is relatively small. That is, in the hole region portion 62, the hole area proportion in the lower region 62D is smaller than the hole area proportion in the upper region 62U.

In this configuration, as compared with a configuration in which the hole area proportion in the lower region 62D is approximately the same as the hole area proportion in the upper region 62U, cold air from the vehicle inner side is suppressed from entering the case 30 through the through-holes 61 on the lower side in the cover part 60. Accordingly, the heater, particularly the lower part, is made less likely to be cooled, whereby unevenness in heat distribution is prevented.

In the above configuration, as compared with a configuration in which the hole area proportion in the upper region 62U is approximately the same as the hole area proportion in the lower region 62D, heat generated by the heater 20 is easily released to the vehicle inner side through the through-holes 61 on the upper side in the cover part 60. Accordingly, heat from the heater 20 is not trapped in the air layer 80, and thus, the upper side in the cover part 60 is prevented from becoming excessively hot.

Therefore, according to the vehicle heater device 10, entry of cold air to the heater side is inhibited while ensuring releasability of heat from the heater to the vehicle inner side. Accordingly, while the heat from the heater is effectively released, decrease in the temperature of the heater is suppressed, whereby the heater efficiency is improved, and the product quality is improved.

In the vehicle heater device 10, the exposure region portion 71 of the functional part 70 is exposed at the front face of the cover part 60 or at the front face of the case 30 but is disposed outside the hole region portion 62 of the cover part 60, and the heater 20 is disposed at a position at which the heater 20 opposes and overlaps the hole region portion 62 and at which the heater 20 does not oppose or overlap the exposure region portion 71, in the front-rear direction of the case 30.

In this configuration, the exposure region portion 71 of the functional part 70 is exposed at the same front face of the cover part 60 or front face of the case 30 as that where the hole region portion 62 of the cover part 60 is provided, and thus, when compared with a configuration in which the exposure region portion 71 is provided at a position outside the front face of the case 30, the sense of unity of the functional part 70 with the case 30 is achieved, and recognizability of the vehicle heater device 10, as a heater, which is difficult to be recognized by the vehicle occupant through mere exposure of the hole region portion 62, is improved.

Even though the exposure region portion 71 is disposed so as to be exposed at the front face of the cover part 60 or the front face of the case 30 as described above, the heater 20 is not disposed on the rear side of the exposure region portion 71. Therefore, as compared with a configuration in which the heater 20 is disposed also on the rear side of the exposure region portion 71, release of heat from the heater, to the vehicle inner side, is suppressed from being hindered by the functional part 70, and the temperature of the functional part 70 is inhibited from becoming high.

Therefore, according to the vehicle heater device 10, while the sense of unity of the functional part 70 with the case 30 is ensured, impairment of releasability of heat from the heater, to the vehicle inner side, is prevented. Thus, also with this, the heater efficiency is improved and the product quality is improved.

The exposure region portion 71 is disposed at a corner (specifically, any one of four corners) in the front face of the case 30, and is adjacent to, at either of the left or the right of, the hole region portion 62. Therefore, as compared with, for example, a configuration in which the exposure region portion 71 is disposed between two corners among the four corners or a configuration in which the exposure region portion 71 is surrounded by the hole region portion 62, release of heat from the heater, to the vehicle inner side, is less likely to be hindered by the functional part 70, and thus, releasability of the heat from the heater, to the vehicle inner side, is improved.

The case 30 has the partition plate 36 extending so as to spread from the boundary between the hole region portion 62 of the cover part 60 and the exposure region portion 71 of the functional part 70 in the front face of the case 30, to the rear wall portion 32. The partition plate 36 sections the accommodation space 34 of the case 30 into the first accommodation space 34a in which the heater 20 is accommodated and the second accommodation space 34b in which the accommodated portion 72 of the functional part 70 is accommodated.

Therefore, the heat generated by the heater 20 is blocked by the partition plate 36, and thus, the temperature of the functional part 70 is prevented from becoming high. Accordingly, for example, in a case where an operation switch is included in the exposure region portion 71 at the front face of the case 30, the vehicle occupant is prevented from becoming unable to touch the same, due to high temperature of the exposure region portion 71.

Meanwhile, in the above embodiment, when the hole area proportion occupied by the through-holes 61 in the lower region 62D is made smaller than the hole area proportion occupied by the through-holes 61 in the upper region 62U, the size of the through-holes 61 in the lower region 62D is made smaller than the size of the through-holes 61 in the upper region 62U, while the distance between the axes of through-holes 61 adjacent to each other in the up-down direction and the left-right direction is maintained at the constant distance L1, L2 over the entire region of the hole region portion 62.

However, the present disclosure is not limited thereto. When the hole area proportion occupied by the through-holes 61 in the lower region 62D is made smaller than the hole area proportion occupied by the through-holes 61 in the upper region 62U, the distance between the axes of through-holes 61 adjacent to each other in at least one of the up-down direction and the left-right direction in the lower region 62D may be made larger than the distance between the axes of through-holes 61 adjacent to each other in at least one of the up-down direction and the left-right direction in the upper region 62U, while the through-holes 61 in the hole region portion 62 are maintained to have a constant area. In this modification as well, the same effects as those in the above embodiment are obtained.

In the above embodiment, the plurality of through-holes 61 in the cover part 60 are each formed, for example, in a regular hexagonal shape or a circular shape, and are arranged in the up-down direction and the left-right direction, to form the hole region portion 62. However, the present disclosure is not limited thereto. The plurality of through-holes 61 may each be formed in a slit shape extending in one of the up-down direction and the left-right direction, and arranged in the other of the up-down direction and the left-right direction, to form the hole region portion 62.

In this modification, the through-holes 61 in a slit shape extending in the up-down direction may be formed such that the slit width in the left-right direction becomes smaller from the upper side toward the lower side, whereby the hole area proportion occupied by the through-holes 61 in the lower region 62D is made smaller than the hole area proportion in the upper region 62U. Alternatively, the through-holes 61 in a slit shape extending in the left-right direction may be formed such that the slit width in the up-down direction of the through-holes 61 in the lower region 62D becomes smaller than the slit width in the up-down direction of the through-holes 61 in the upper region 62U, whereby the hole area proportion occupied by the through-holes 61 in the lower region 62D is made smaller than the hole area proportion in the upper region 62U.

In the above embodiment, the cover part 60 is formed in a shape adjusted to the shape (specifically, quadrangular shape or the like) of the front face of the case 30, the hole region portion 62 is provided in a part of the front face of the cover part 60, and the exposure region portion 71 of the functional part 70 is provided so as to be exposed at another part of the front face of the cover part 60. However, the present disclosure is not limited thereto. The cover part 60 may be formed in a shape smaller than the shape of the front face of the case 30, the hole region portion 62 may be provided in the entire region of the front face of the cover part 60, and the exposure region portion 71 of the functional part 70 may be provided so as to be exposed not at the front face of the cover part 60 in which the hole region portion 62 is provided, but in a place, in the front face of the case 30, that is not the cover part 60.

The present disclosure is not limited to the above-described embodiment and the like, and various changes may be made without departing from the gist of the present disclosure. The specification discloses not only technical features shown by the reference relationship described in the claims at the time of filing of the present application but also technical features obtained by combining matters described in the claims as appropriate.

This application claims priority on Japanese Patent Application No. 2025-078696 filed on May 9, 2025, the entire contents of which are incorporated herein by reference.

1. A vehicle heater device comprising:
a heater as a heat source;
a case accommodating the heater;
a cover part having a hole region portion in which a plurality of through-holes connecting inside and outside of the case are provided, the cover part being provided at least in a part of a front face of the case; and
a functional part having an exposure region portion exposed at a front face of the cover part or the front face of the case, wherein
the exposure region portion is disposed outside the hole region portion, and
the heater is disposed at a position at which the heater opposes and overlaps the hole region portion and at which the heater does not oppose or overlap the exposure region portion, in a front-rear direction of the case.

2. The vehicle heater device according to claim 1, wherein the exposure region portion is disposed at a corner in the front face of the case, and is adjacent to the hole region portion.

3. The vehicle heater device according to claim 2, wherein
the front face of the case is formed in a quadrangular shape, and
the exposure region portion is disposed at the corner being any one of four corners of the front face of the case, and is adjacent to, at either of left and right of, the hole region portion.

4. The vehicle heater device according to claim 1, wherein the case has a partition plate extending so as to spread from a boundary between the hole region portion and the exposure region portion in the front face of the case, to a rear wall portion of the case.

5. The vehicle heater device according to claim 4, wherein
the functional part has an accommodated portion extending on a rear side of the exposure region portion and accommodated in the case, and
the partition plate sections an accommodation space of the case into a first accommodation space in which the heater is accommodated and a second accommodation space in which the accommodated portion is accommodated.
